(19) United States
(12) Patent Application Publication
(10) Pub. No.: US 2003/0184557 A1
(43) Pub. Date: Oct. 2, 2003

(54) Interactive method and apparatus for managing color gamut mapping

(76) Inventor: Senfar Wen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/105,242

(22) Filed: Mar. 26, 2002

(51) Int. Cl. G09G 5/02

(52) U.S. Cl. 345/590

(57) ABSTRACT

A method and system for managing color gamut mapping of a digital image from a source gamut to a target gamut through the graphical user interface including offset-color-shift and color-difference diagrams, which assists a user, no matter who is professional or not, in easily identifying the color shift of the image, conveniently tuning the gamut mapping method, and editing image color so that a desired result can be obtained for the target device.

### FIELD OF THE INVENTION

The present invention relates to computerized manipulation of color gamut mapping of digital images between a source gamut, for example the color gamut of an image input device, and a target gamut, for example the color gamut of an image output device, and more particularly to a graphical user interface (GUI) for assisting a user in identifying the color shift of the image, tuning gamut mapping method, and editing image color so that a desired result can be obtained for the target device.

### BACKGROUND OF THE INVENTION

Computer-based graphics software systems for displaying and/or editing digital images are commercially available for experts and pro-summers in digital imaging. One of the functions of the systems is to convert the images from their source gamut, for example the color gamut of an image input device, to a destination gamut, for example the color gamut of an image output device. This function is called the gamut mapping. Although color perception is subjective, color can be described with a set of numerical numbers, for example the well-known CIE color systems. With such color systems, all the colors that a digital image input or output device that can produce are the color gamut of the device. Usually the source gamut and destination gamut are different which results in unfaithful color rendering in general. As known to those skilled in this art, numerous methods of gamut mapping are developed and they are built in the software systems.

Four rendering intents are usually taken. Colorimetric rendering faithfully reproduces the colors within target gamut while the out-of-gamut color is clipped and is unfaithfully reproduced. The clipping means that the digital counts required to reproduce the color with the output device are out of range and are forced to be set to the limits of digital counts, for example the limits are 0 or 255 for an 8-bit digital number. Relative calorimetric rendering converts the source white to the target white and all the other colors are shifted accordingly so that all the brightness levels of colors are within the target gamut. Perceptual color rendering compresses source gamut to fit in the target gamut but the colors keep their relative chromatic positions. Saturation rendering is designed to map the highest saturation colors in source gamut to the highest saturation colors in target gamut and all original colors are modified accordingly. The four rendering intents meet different purposes of applications.

Today consumers are very likely to use such graphics software systems because scanner, digital still-image camera, ink-injection color printer are affordable and popular. Professional users know about the pros and cons of the rendering intents but not for inexperienced consumers who do not have the necessary technical knowledge. In addition, there may have many options and/or numerical parameters that affect the gamut mapping methods built in the software systems. This may lead to the technical barrier, or the confusion and misuse of the gamut mapping methods for inexperienced users. Even for experienced users, they also sometimes take many efforts to tune the gamut mapping methods and edit image color to obtain a desirable result.

For e-commerce application, in the state of art, visitors of a web page usually doubt the color fidelity of the image shown on the page and hesitate to go online shopping when the interested merchandises are color sensitive. Because the image color gamut and the monitor gamut are both unknown, the color of such an image is not reliable. There is a de facto color standard of digital image named sRGB standard, which is promoted by Hewlett-Packard and Microsoft and basically follows the ITU-R BT.709. Even if the web image provider takes the sRGB standard, which is the source color space, and there is the visitor's monitor profile, which describes the target color space, the image color is still questionable because the two color spaces are usually not the same and their gamut are different. The difference may result in the loss of color fidelity.

For color printer application, printing a high-quality color image is usually pre-proofed on the display of a computer system to save the time and cost. As the color gamut of the monitor and printer usually differ much, the proof is also not reliable. One method to solve the problem is to limit the gamut of image so that the gamut lies within the intersection gamut of monitor and printer.

### SUMMARY OF THE INVENTION

It is therefore the objective of the present invention to provide a GUI showing the offset-color-shift and color-difference diagrams on the display of the computer system executing the GUI program for the image shown on the target device so that the effects of the gamut mapping methods on the color shift can be clearly observed. The computer display itself may also be the target device. When the target device is not the computer display, it is the display of the other computer system, a color printer, or the other output devices.

It is the other objective of the present invention to provide a GUI indicating the color shift and color difference of the image pixels that are shown on the offset-color-shift diagram and color-difference diagram respectively so that users can tune the gamut mapping methods, edit the image color to reduce the color shift or to achieve preferred color shift.

It is also an object of the present invention to provide a GUI assisting a user, no matter who is professional or not, in identifying the color shift of the image, conveniently tuning the gamut mapping method, and editing the image color so that a desired color appearance of the image can be obtained for the target device.

A user can interactively identify the color shift of the image shown on a web page with the GUI of the present invention embedded in or added on the web browser if the gamut mapping method is known and both the color gamut of the image and monitor are known. With the present invention, the GUI is again able to interactively assist pre-proofing for a color printer output, if the color gamut of the image input device, computer display, and printer are known. A user can interactively edit image color with the GUI of the present invention.

### BRIEF DESCRIPTION OF THE DRAWINGS

FIG. 1 illustrates an (a) image diagram, (b) offset-color-shift diagram, and (c) color-difference diagram.

FIG. 2 illustrates cross symbols and arrow symbols appearing when a mouse pointer is moved to either one of the (a) image diagram, (b) offset-color-shift diagram, or (c) color-difference diagram.

FIG. 3 illustrates the first GUI for the application of offset-color-shift diagram and color-difference for an image diagram shown on a web page, where the two diagrams are generated when an activation button nearby an image diagram is enabled with a mouse pointer.

FIG. 4 illustrates the second GUI for the application of offset-color-shift diagram and color-difference for an image diagram shown on a web page, where the two diagrams are generated when an activation button located in a command window is enabled with a mouse pointer.

FIG. 5 illustrates the third GUI for the application of offset-color-shift diagram and color-difference for an image diagram shown on a web page, where the two diagrams are not generated when an activation button located in a command window is enabled with a mouse pointer but showing the offset-color-shift patch, offset-color patch, color-space diagram, and the value of color difference in the command window in stead.

FIG. 6 illustrates the GUI for the application of offset-color-shift diagram and color-difference for the pre-proof of color printer.

### DETAILED DESCRIPTION OF THE PREFERRED EMBODIMENT

The present invention is described hereinafter with reference to the accompanying drawings, in which a preferred embodiment of the invention is shown. This invention may be embodied in many different forms and should not be constructed as limited to the embodiments set forth herein.

Color fidelity is generally lost for the color of an image from its source gamut to the target gamut when they are not the same. To accommodate target gamut, the source gamut may be expanded or compressed, which depends on the application and what gamut mapping method are used. In some instances, the gamut mapping method with absolute rendering intent is preferred but the out-of-gamut color is clipped.

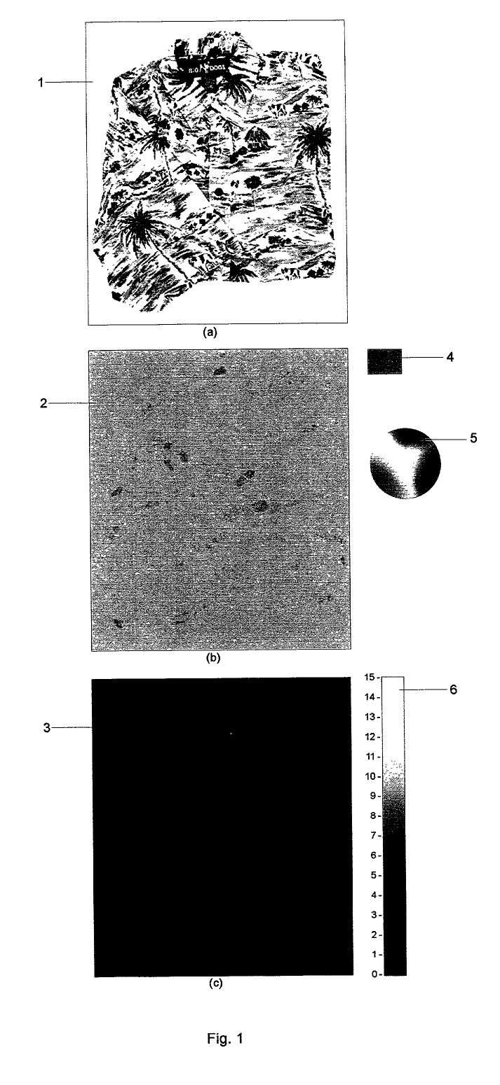

Device color space is its color gamut described with a color coordinate system. With a uniform color space, for example the CIE LAB or CIE LUV, image color coordinates in the source color space and in the target color space can be conveniently manipulated. This invention uses offset-color-shift diagram 2 and color-difference diagram 3 accompanying with the image diagram 1 shown on the computer display as are shown in FIG. 1 so that a user can clearly identify and modify the color shift and color difference of the image. FIG. 1 shows an example and the other modifications of the diagrams are possible. Basically the offset-color-shift diagram 2 is generated according to the difference vector of the color coordinates of the image pixels image in source color space and target color space. The color-difference diagram 3 is generated according to a color difference formula. In the following we take CIE LAB color coordinate system as an example to explain this invention.

Supposing (L*s, a*s, b*s) and (L*t, a*t, b*t) are the color coordinates of an image pixel in the source and target color spaces respectively, we can calculate the color shift as a set of three numbers:

ΔL*=L*t−L*s

Δa*=a*t−a*s (1)

Δb*=b*t−b*s

Then the color represented in CIE LAB color coordinate system as

L*=L*offset+aΔL*

a*=aΔa* (2)

b*=aΔb*

is plotted on the corresponding pixel of the offset-color-shift diagram on the computer display, where L*offset is an offset lightness to avoid negative lightness and a is a user defined factor to enhance the color shift when it is slight and barely to be observed. L*offset can be manually or automatically set. The vector (ΔL*, Δa*, Δb*) represents the color shift of the color of coordinate (L*t, a*t, b*t) from the color of coordinate (L*s, a*s, b*s). The color of coordinate (L*, a*, b*) is called the offset-color-shift. Although some image color cannot be shown on the computer display, as the color coordinate (L*, a*, b*) is of low lightness and low saturation so that it can be shown with the computer display. A reference color patch 4 of the color (L*=L*offset, a*=0, b*=0) is shown nearby the offset-color-shift diagram for comparison, which is usually gray color. The reference color is called the offset color. The lightness of the image pixel on the target device is higher than the corresponding image pixel on the source device if the lightness of the corresponding pixel on the offset-color-shift diagram is larger than the offset color and vice versa. Here shows an example to evaluate how color is shifted. The color of an image pixel on the target device is either more bluish or less yellowish than the corresponding image pixel on the source device if the corresponding pixel on the offset-color-shift diagram shows blue color. If the corresponding image pixel on the target device contains more green and blue colorants, then the color shift is more bluish and the color more saturated. On the other hand, if the corresponding image pixel on the target device contains more green and red colorants, then the color shift is less yellowish and the color is less saturated. An arrow 8 indicating the color shift on a color-space diagram 5, such as the well-known color triangle and color wheel, can be shown on the computer display to assist a user in identifying the color shift. The arrow is called the color-shift arrow. The color-space diagram is used to indicate the positions of the color in source color space and target color space. When a pointing device, for example the mouse of the computer, points to an interested image pixel, the color-shift arrow is shown on the color-space diagram. In the following, the pointing device is taken as a mouse for an example, which is also shown in FIG. 1. Therefore, with the offset-color-shift diagram, a user can easily identify what image pixels are color-shifted and how the color is shifted. When the color shift is slight and cannot be clearly observed, there is a up-down button 22 for adjusting the a factor to enhance the color shift appearance so that user can see what color shift is. Nearby the button, there is a message box 24 for showing the value of a factor and a reset button 23 for setting the a factor to unit.

Furthermore, for a user to manage gamut mapping, the corresponding number representing color difference is also helpful. Several color difference formulas may be defined for the color coordinate system in use. The simplest formula recommended by CIE is

ΔE=\sqrt{(ΔL*)²+(Δa*)²+(Δb*)²} (3)

The other more complicated and accurate formulas are also available and are well known to those skilled in this art. The color difference number can be provided with two methods. When the mouse pointer 11 of the computer display 10 points to an image pixel, the numerical value of the color difference of the pixel is shown on the message box 25. The other is to represent the numerical value with gray color on the color-difference diagram, nearby which a gray scale 6 is presented for relating the gray color and the numerical value. The scale is called the color-difference scale.

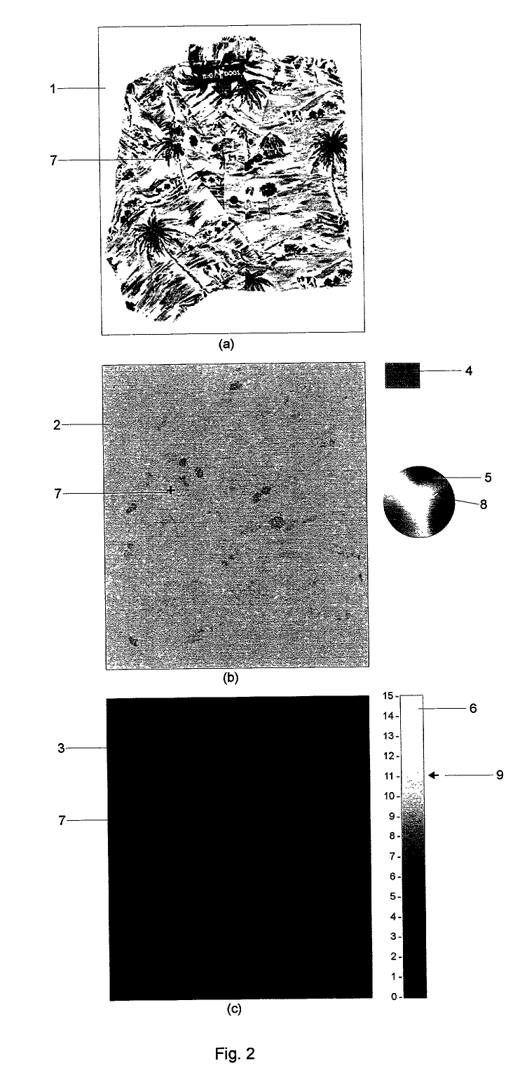

When the mouse pointer 11 is moved within the image diagram 1, it becomes to a cross symbol 7 and the corresponding pixels in the offset-color-shift and color-difference diagrams also respectively show cross symbols so that a user can easily identify the color information of the pixel which the mouse points to. On the color-difference scale 6, the corresponding color difference of the selected pixel is indicated 10 with an arrow 9. In addition, when the mouse pointer is moved to either one of the image diagram, offset-color-shift diagram, or color-difference diagram, the cross symbols appear on the other two diagrams. FIG. 2 shows an example of the usages of the cross symbols 7 and arrows 8, 9. The sizes of the diagrams are not necessarily to be same as the image and can be expanded, shrunk, or zoomed to accommodate the limited size of the computer display. Based on the diagrams, a user can easily identify the color shift, tune gamut mapping method, and edit image color with accompanying GUI shown on the computer display for some specific application. The following shows some application examples.

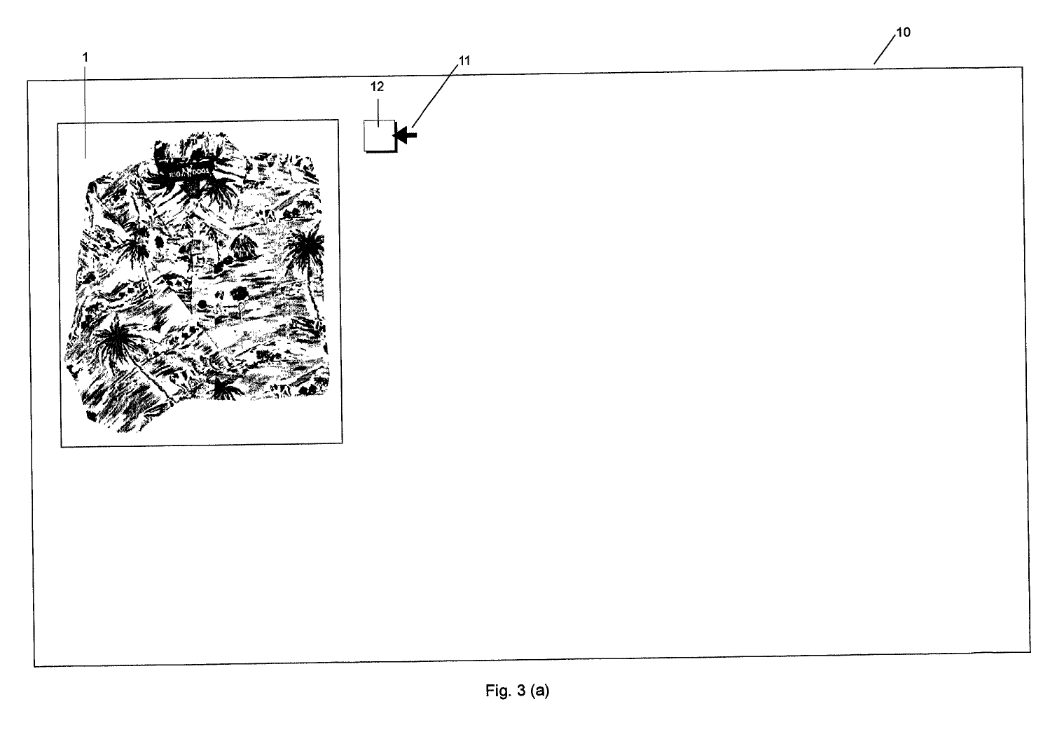

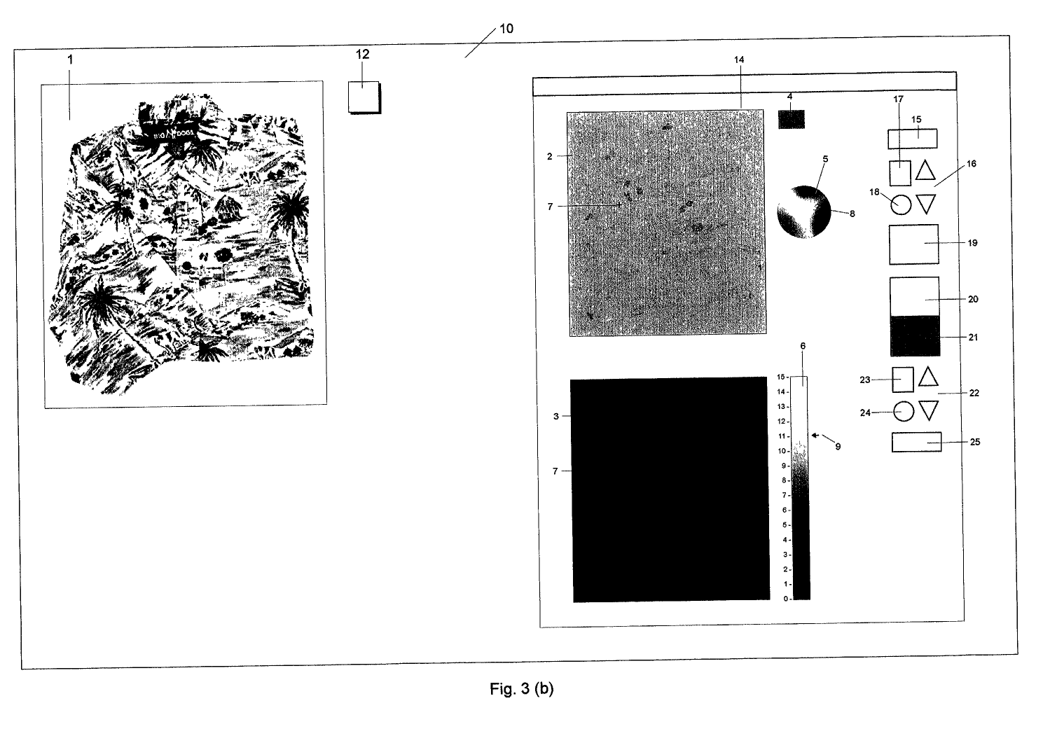

For e-commerce application, the image shown on a web page usually requires high-fidelity color. To provide high-fidelity color images, web image provider can follows a color standard, such as sRGB standard, to prepare the images or embeds the color profile in the images, then the source color space of the image can be known to the web browser. To view high-fidelity color, web browser must also know the color profile of computer display and be able to identify the image source color space. Thus web browser can use the gamut mapping method with absolute rendering intent to convert the image based on the both color spaces of source device and computer display. However, as is notified previously, there are color shift for the image shown on the computer display due to the two color spaces are different generally. User can easily and clearly know about the color fidelity of the image through clicking the activation button 12 nearby the image with a mouse 11 of the computer system 10 to select the image diagram and activate the computer code, which is built in the browser or is added on the browser, to create a window 14 showing the offset-color-shift diagram 2 and color-difference diagram 3 of the image diagram 1 as are shown in FIG. 3(a). FIG. 3(b) shows the created window 14, in which there are a button 15 for re-plotting the diagrams; up-down button 16 for adjusting image lightness, which will be explained in the next paragraph; a message box 17 showing the value of lightness increment factor; the button 18 for resetting the lightness increment factor; the color patch 19 showing selected pixel color; color patch 20 showing the color of offset-color-shift; color patch 21 showing offset-color; a up-down button 22 for adjusting color-shift enhancement a factor; a message box 23 showing the value of a factor; the button 24 for resetting a factor; and a message box 25 showing the value of color difference. The lightness adjustment 16-18 and the a factor adjustment 22-24 apply to all image pixels; while the color patches of 19 and 20, and the message box 25 relate to the selected image pixel with a mouse pointer. The procedures to generate the pixels of the offset-color-shift and color-difference diagrams relating to a pixel of the image diagram are:

1.1. Calculate the coordinate (L*s, a*s, b*s) of the image pixel in the color space of image source device.

1.2. Transform the coordinate (L*s, a*s, b*s) into the coordinate (L*d, a*d, b*d) in the color space of the computer display with absolute rendering intent.

1.3. Calculate ΔL*=L*d−L*s, Δa*=a*d−a*s, Δb*=b*d−b*s.

1.4. Calculate RGB digital counts for the computer display to show the color of the offset-color-shift coordinate (L*offset+aΔL*, aΔa*, aΔb*) in the color space of the computer display.

1.5. Calculate ΔE according to the coordinate (L*d, a*d, b*d)and (L*s, a*s, b*s).

The image diagram shown on the system display is according to the color coordinate (L*d, a*d, b*d). As the color of the offset-color-shift coordinate (L*offset+aΔL*, aΔa*, aΔb*) is of low saturation and is usually within the display gamut, it can be shown with the computer display.

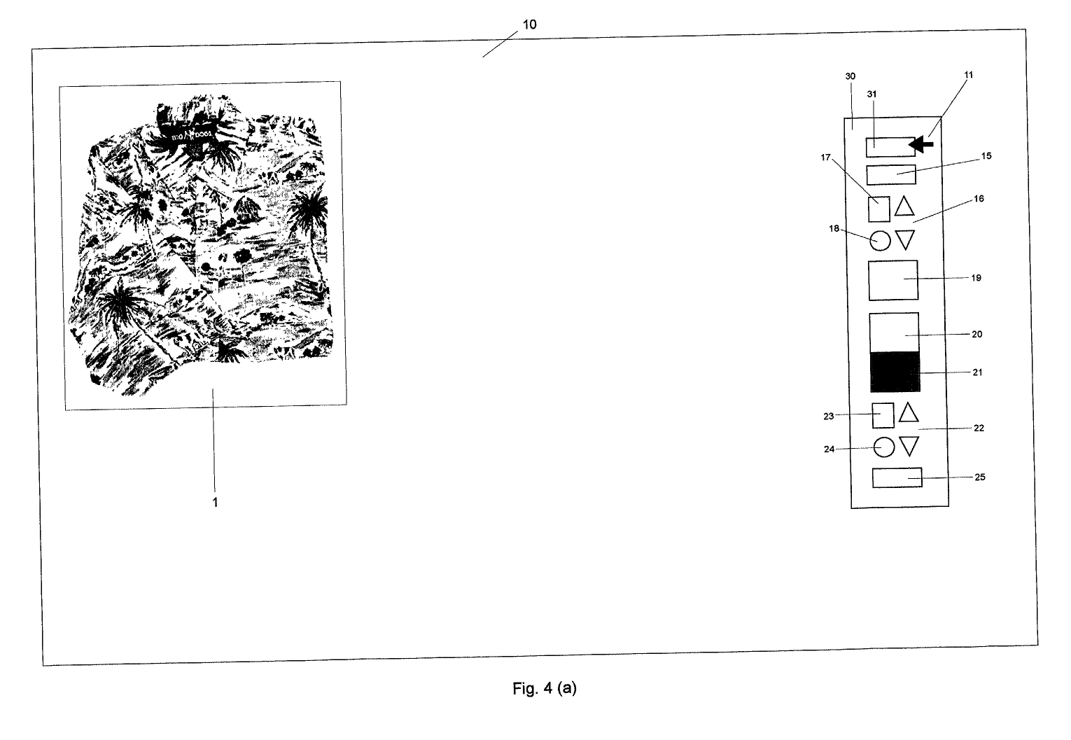

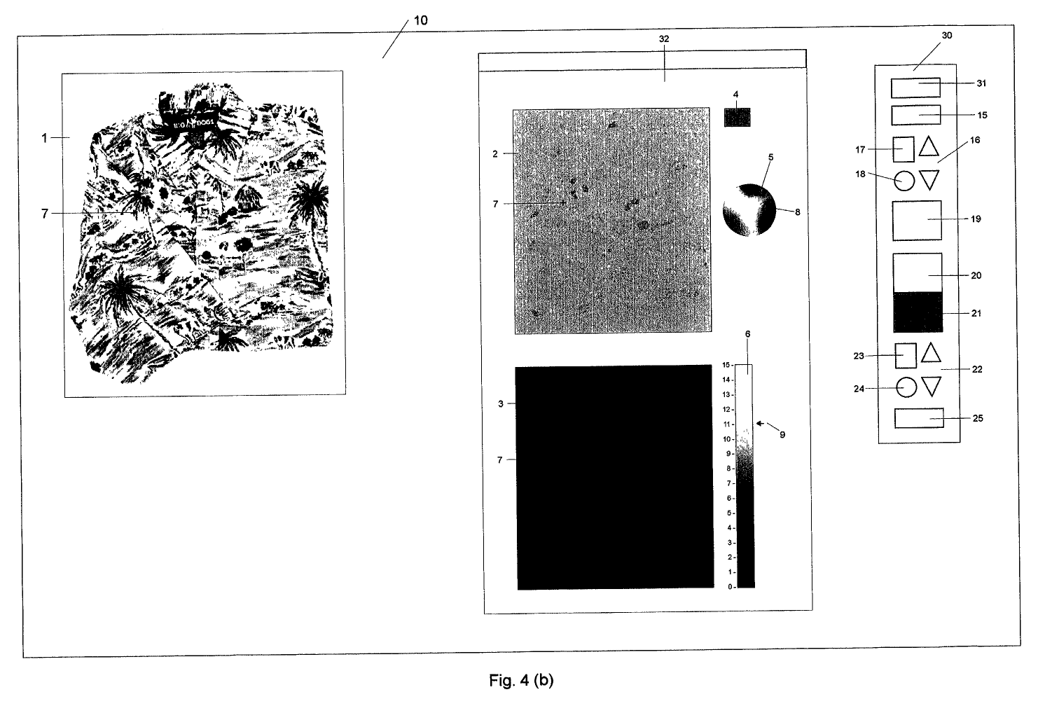

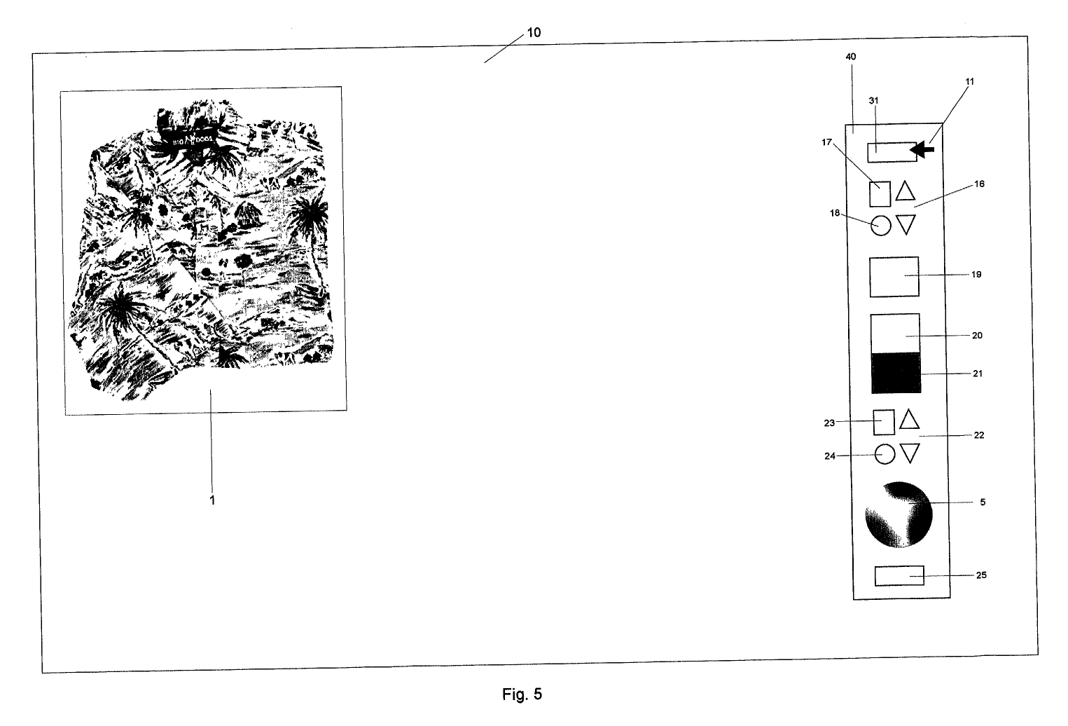

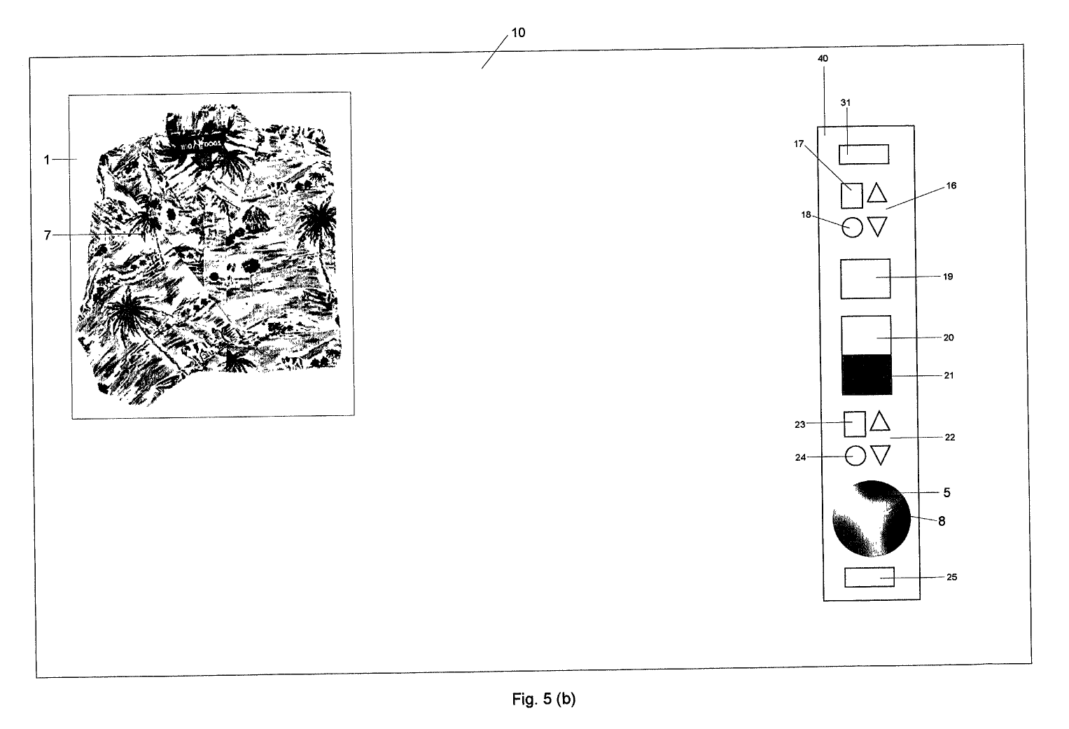

Another approach is to click the activation button 31 in the command window 30 shown in FIG. 4(a) with the mouse pointer to enable the functions and then to double click the image diagram to select the image and to create a window 32 containing the offset-color-shift and color-difference diagrams as is shown in FIG. 4(b). Another simplified approach is not to show offset-color-shift and color-difference diagrams but only to show the offset-color-shift and color difference of a selected image pixel as is shown in FIG. 5. FIG. 5(a) shows the enabling the activation button 31 with a mouse pointer 11 in the command window 40. Then the image diagram is double clicked with the mouse and is selected. When the mouse is moved to the image diagram, the color, offset-color-shift, and color difference of the selected pixel are shown in the color patches and message boxes of the command window as is shown in FIG. 5(b), where the color-space diagram is also included.

As the source and target gamut are different, in addition to clip out-of-gamut color, lightness compression is usually taken to accommodate different white points of the source and target devices. When lightness compression is taken, the brightness of the image color may look dim. In such an instance, a lightness adjustment up-down button 16, a message box 17 showing the increment of lightness, and a reset button 18 of lightness increment are provided. To avoid too much lightness increment, proper limitation of the increment is desired. Upon increasing the image lightness, dim colors look brighter and thus may be more close to real color appearance but low saturation and high lightness colors may be clipped. However a user will not be misled for the clipping because the pixels with clipped colors will be clearly shown on the offset-color-shift and color-difference diagrams.

Today the advance of printer technology significantly improves the printer gamut, which may beyond the gamut of computer display in part. The following describes the application of offset-color-shift and color-difference diagrams to the printer output.

The objective of printer pre-proof function is to achieve the goal of “what you see is what you get (WYSIWYG)”. Image is generated from an image source device, such as digital still image camera and scanner, or from computer graphics. For the case from computer graphics, the color gamut of the display used for editing the image is possibly different from the computer display used for pre-proof. Because the color gamut of image source device, pre-proof computer display, and printer are generally different, their intersection gamut must be smaller than the respective gamut. Therefore, it is actually hard to achieve WYSIWYG in general. If the strategy to limit the image gamut to within the intersection gamut is taken to achieve WYSIWYG, the richness of the color gamut must be sacrificed. With the help of the offset-color-shift and color-difference diagrams generated according to the color spaces of image source device and printer, user can expect what color will be printed for the out-of-gamut color of the computer display. The procedures to generate the pixels of the offset-color-shift and color-difference diagrams relating to a pixel of the image diagram are:

2.1. Calculate the coordinate (L*s, a*s, b*s) of the image pixel in the color space of image source device.

2.2. Transform the coordinate (L*s, a*s, b*s) into the coordinate (L*p, a*p, b*p) in the color space of printer with a specified gamut mapping method.

2.3. Calculate ΔL*ps=L*p−L*s, Δa*ps=a*p−a*s, Δb*ps=b*p−b*s.

2.4. Calculate RGB digital counts for the computer display to show the color of the offset-color-shift coordinate (L*offset+aΔL*ps, aΔa*ps, aΔb*ps) in the color space of the computer display.

2.5. Calculate ΔE according to the coordinates (L*p, a*p, b*p) and (L*s, a*s, b*s).

2.6. Transform the coordinate (L*p, a*p, b*p) into the coordinate (L*d, a*d, b*d) in the color space of computer display with absolute rendering intent.

2.7. Calculate ΔL*dp=L*d−L*p, Δa*dp=a*d−a*p, Δb*dp=b*d−b*p.

2.8. Calculate RGB digital counts for the computer display to show the color of the offset-color-shift coordinate (L*offset+aΔL*dp, aΔa*dp, aΔb*dp) in the color space of the computer display.

It is noticed that the gamut mapping method used in procedure 2.2 may not be with absolute rendering intent in general. In some instances the gamut mapping method with absolute rendering intent in procedure 2.2 results in an undesirable output image due to gamut clipping. There are two offset-color-shift diagrams in this case. One is for the image source device and printer. The other is for the printer and computer display. As the color of the coordinate (L*offset+aΔL *ps, aΔa*ps, aΔb*ps) or (L*offset+aΔL*dp, aΔa*dp, aΔb*dp) is of low saturation and is usually within the display gamut, it can be shown on the display. The image diagram shown on the system display is according to the color coordinate (L*d, a*d, b*d). If viewing the image in source device is required, one can follow the method described in the application to the web browser for reproducing the image color in the computer display. Thus this approach can indirectly meet the goal of WYSIWYG without sacrificing the richness of the printer gamut and also can identify the color shift and color difference of the image between source device and printer.

For the GUI used in printer pre-proof application, in addition to the accompanying GUI described in web browser, user should be able to further edit the image color through the help of the offset-color-shift and color-difference diagrams because the output result may not meet user's preference.

There may have the “global-pixel”, “local-pixel”, “global-color”, and “local-color” options for editing an image, in which the pixel option and color option are not exclusive and therefore there are the combination edit modes such as “global-pixel-global-color”, “local-pixel-global-color”, “global-pixel-local-color”, and “local-pixellocal-color” modes. The edit mode with “global-pixel” option applies edit commands to all image pixels, while the edit mode with “local-pixel” option only applies to the selected pixels or areas of the image. The edit mode with “global-color” option applies edit commands to all color, while the edit mode with “local-color” option only applies to the selected colors of the image. The said edit commands are the commands to change the parameters used in the gamut mapping method; the ratios among the red, green, blue colorants for additive color system; the ratios among cyan, magenta, yellow, and black colorants for subtractive color system; the lightness, hue, and saturation of the selected color; and so on for the edited pixels and color. Note that the image color can be edited through the image diagram, offset-color-shift diagrams, and color-difference diagram. In many instances, the edited pixels are clustered for the image diagram, offset-color-shift diagrams, and color-difference diagram. Therefore, the GUI tools indicating the clustered pixels are helpful, for examples a GUI tool to selected an area of geometrical shape in the diagrams, and a GUI tool with an object recognition function identifying the space boundary of an object. If this function is applied to the image diagram, user can easily edit the color of a thing in the image. If this function is applied to the offset-color-shift diagram to select an area with unwanted color shift user can easily edit the color of the corresponding pixels of the area in image diagram. If this function is applied to the color-difference diagram to select an area with unwanted color difference, user can easily edit the color of the corresponding pixels of the area in image diagram. The edited color can be selected with the logical operations for the conditions of the color value of image diagram, the color shift of offset-color-shift diagrams, and the color difference of color-difference diagram that is to be edited in the selected image pixels. For examples the conditions can be the color value within some range of lightness, hue, and saturation; the color shift within some range of lightness, hue, and saturation; and some range of color difference.

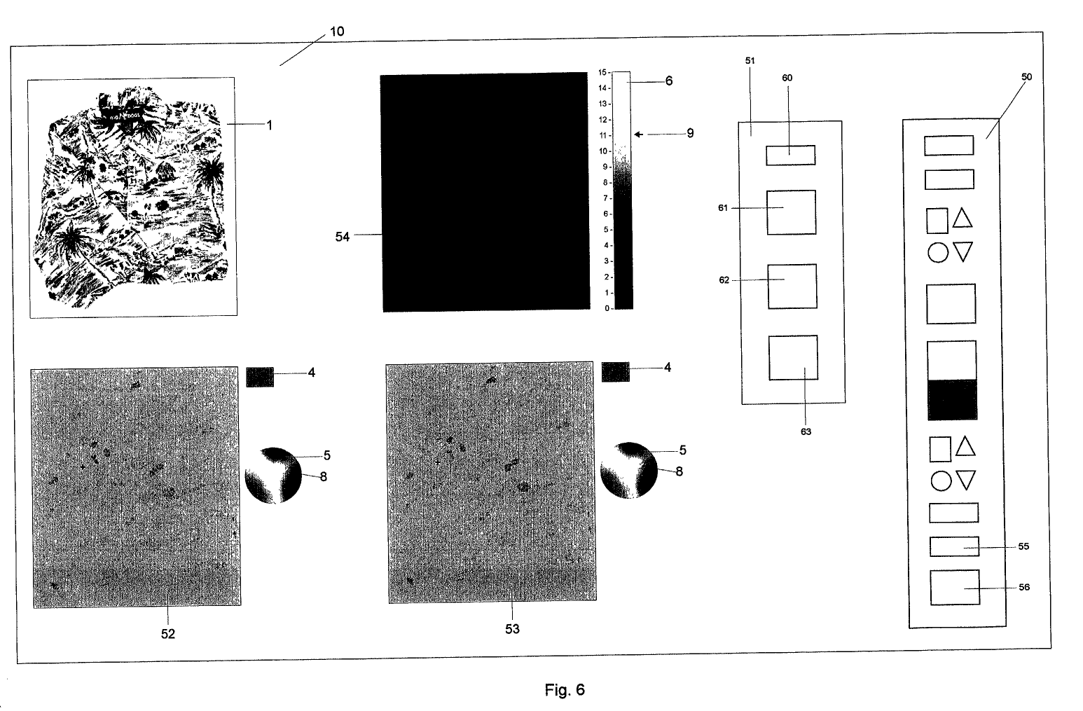

FIG. 6 shows a GUI example for the printer pre-proof and color editing application. In addition to the diagrams, buttons, color boxes, messages boxes shown in FIG. 4, there are gamut mapping option combo box 55 in the command window 50 and the input box 56 for editing the accompanying numerical parameters for the selected mapping method. Once the gamut mapping method is chosen and the accompanying numerical parameters are also given, the image color is mapped to the printer color space and the offset-color-shift diagram 52 for the image source device and printer, the offset-color-shift diagram 53 for the printer and computer display, and the color-difference diagram 54 for image source device and printer are created. An edit tool window 51 is created, which contains an edit mode option combo box 60, a tool box 61 for selecting edited image pixels, a tool box 62 for selecting edited color, and a tool box 63 for editing the selected image color of the selected image pixels.

For graphics software systems for displaying and/or editing digital images, their applications are general purpose but the applications of the offset-color-shift and color-difference diagrams to them are similar to the web browser and color printer. If color fidelity is concerned, absolute rendering intent is taken and the GUI similar to the GUI described in the web browser application can be applied. If color fidelity is not concerned, the offset-color-shift diagram is also helpful for editing the color appearance to meet a user's preference because it conveniently provides user about what color shift is tuned and the GUI similar to the application to color printer can be applied. For example, the graphics software system usually provides the functions to tune the amounts of colorants or to tune the lightness, hue, and saturation. When such functions of the graphics software system are used to adjust color appearance to meet user's preference, the other colors are changed accordingly. Therefore, with the help of the mouse pointer and offset-color-shift diagram, a user can focus on editing the colors they want to change and how much color shift is needed with the editing methods described in the printer application.

What is claimed is:

1. A method for showing the color shift on a display for an image pixel between two color spaces that are represented with the same uniform color coordinate system, comprising:
calculating a color-shift coordinate which is the difference of the two coordinates respectively representing the color of an image pixel in the two color spaces;
calculating an offset-color-shift coordinate which is the sum of a coordinate of a neutral color plus the said color-shift coordinate, in which the neutral color is also called offset-color;
calculating the input values for the display to show the color of the said offsetcolor-shift coordinate in the color space of the display; and
displaying the color of the said offset-color-shift coordinate on the display.

2. The method of claim 1, further comprising:
modifying the said offset-color-shift coordinate with the color-shift coordinate multiplied by a color-shift enhancement factor to increase the lightness and saturation of the color of the offset-color-shift coordinate.

3. A method for showing the color shift on a display for an image between two color spaces that are represented with the same uniform color coordinate system, comprising:
calculating a color-shift coordinate which is the difference of the two coordinates respectively representing the color of an image pixel in the two color spaces;
calculating an offset-color-shift coordinate which is the sum of a coordinate of a neutral color plus the said color-shift coordinate, in which the neutral color is also called offset-color;
calculating the input values for the display to show the color of the said offsetcolor-shift coordinate in the color space of the display;
displaying the color of the said offset-color-shift coordinate on the display; and
displaying the color of the said offset-color-shift coordinates of the image pixels on an offset-color-shift diagram on the display, in which the relative positions of the pixels of image diagram and the said offset-color-shift diagram remain the same so that a user can identify the color shift of a pixel of the image diagram by observing the color of the corresponding pixel of the said offset-color-shift diagram.

4. A method for showing the color shift on a display for an image pixel between two color spaces that are represented with the same uniform color coordinate system, comprising
calculating a color-shift coordinate which is the difference of the two coordinates respectively representing the color of an image pixel in the two color spaces;
calculating an offset-color-shift coordinate which is the sum of a coordinate of a neutral color plus the said color-shift coordinate, in which the neutral color is also called offset-color;
calculating the input values for the display to show the color of the said offsetcolor-shift coordinate in the color space of the display:
displaying the color of the said offset-color-shift coordinate on the display: and
displaying the color of the said offset-color-shift coordinates of the image pixels on an offset-color-shift diagram on the display, in which the relative positions of the pixels of image diagram and the said offset-color-shift diagram remain the same so that a user can identify the color shift of a pixel of the image diagram by observing the color of the corresponding pixel of the said offset-color-shift diagram.

5. The method of claim 1, further comprising:
displaying a color patch of the said offset-color on the display so that a user can compare the color of the said offset-color-shift coordinate to this color patch and identify the color shift.

6. The method of claim 2, further comprising:
displaying a color patch of the said offset-color on the display so that a user can compare the color of the said offset-color-shift coordinate to this color patch and identify the color shift.

7. The method of claim 3, further comprising:
displaying a color patch of the said offset-color on the display so that a user can compare the color of the said offset-color-shift coordinate to this color patch and identify the color shift.

8. The method of claim 4, further comprising:
displaying a color patch of the said offset-color on the display so that a user can compare the color of the said offset-color-shift coordinate to this color patch and identify the color shift.

9. The method of claim 1, further comprising:
displaying the positions of the color of the image pixel in the two color spaces on a color-space diagram shown on the display so that a user can identify the color shift.

10. The method of claim 2, further comprising:
displaying the positions of the color of the image pixel in the two color spaces on a color-space diagram shown on the display so that a user can identify the color shift.

11. The method of claim 3, further comprising:
displaying the positions of the color of the image pixel in the two color spaces on a color-space diagram shown on the display so that a user can identify the color shift.

12. A method for showing the color difference on a display for an image pixel between two color spaces that are represented with the same uniform color coordinate system, comprising:
calculating the color difference of the two coordinates respectively representing the color of an image pixel in the two color spaces according to a color difference formula that is known to those skilled in the field of this art;
transforming the said color difference into the input values of the display so that the value of the said color difference can be identified by the color shown on the display with the input values; and
displaying the color representing the value of the said color difference on the system display with the input values.

13. A method for showing the color difference on a display to the image pixels between two color spaces that are represented with the same uniform color coordinate system, comprising:
calculating the color difference of the two coordinates respectively representing the color of an image pixel in the two color spaces according to a color difference formula that is known to those skilled in the field of this art;
transforming the said color difference into the input values of the display so that the value of the said color difference can be identified by the color shown on the display with the input values;
displaying the color representing the value of the said color difference on the system display with the input values: and
displaying the color representing the values of the said color differences of the image pixels on a color-difference diagram on the display, in which the relative positions of the pixels of image diagram and the said color-difference diagram remain the same so that a user can identify the color difference of a pixel of the image diagram by observing the color of the corresponding pixel of the said color-difference diagram.

14. The method of claim 12, further comprising:
displaying a color-difference scale on the display, which relates the color representing the value of the said color difference to the value of the said color difference.

15. The method of claim 13, further comprising:
displaying a color-difference scale on the display, which relates the color representing the value of the said color difference to the value of the said color difference.

16. A method for showing the color shift of an image between a source color space and the color space of a display of a computer system, comprising the steps of:
A. calculating the color values of the image pixel in system display color space according to a specified gamut mapping method and displaying the color on the corresponding pixel in an image diagram on the system display;
B. calculating the color values of the offset-color-shift coordinate for the image pixel; and displaying the color of the said offset-color-shift on the corresponding pixel in an offset-color-shift diagram on the system display; and
C. repeating step A until all image pixels are processed.

17. A method for showing the color difference of an image between a source color space and the color space of a display of a computer system, comprising the steps of:
A. calculating the color values of the image pixel in system display color space according to a specified gamut mapping method and displaying the color on the corresponding pixel in an image diagram on the system display;
B. calculating the color difference for the image pixel;
C. transforming the said color difference into the input values of the display so that the value of the said color difference can be identified by the color shown on the display with the input values;
D. displaying the color representing the value of the said color difference on the corresponding pixel in a color-difference diagram on the system display; and
E. repeating step A until all image pixels are processed.

18. An initializing process, comprising:
specifying an uniform color coordinate system;
specifying an image source color space;
specifying the system display color space;
specifying a gamut mapping method with absolute rendering intent for transforming the color values of the image from source color space into system display color space;

19. A method for showing the color shift of an image between a source color space and a target color space with a display of a computer system, comprising the steps of:
A. calculating the color values of an image pixel in source color space;
B. calculating the color values of the image pixel in target color space;
C. calculating the color values of the image pixel in system display color space and displaying the color on the corresponding pixel in an image diagram on the system display;
D. calculating the color values of the offset-color-shift coordinate of the image pixel in the source color space and target color space and displaying the color of the said offset-color-shift on the corresponding pixel in an offset-color-shift diagram on the system display; and
E. repeating step A until all image pixels are processed.

20. A method for showing the color shift of an image between a target color space and the color space of a display of a computer system, comprising the steps of:
A. calculating the color values of an image pixel in source color space;
B. calculating the color values of the image pixel in target color space;
C. calculating the color values of the image pixel in system display color space and displaying the color on the corresponding pixel in an image diagram on the system display;
D. calculating the color values of the offset-color-shift coordinate of the image pixel in the system display color space and target color space and displaying the color of the said offset-color-shift on the corresponding pixel in an offset-color-shift diagram on the system display; and
E. repeating step A until all image pixels are processed.

21. A method for showing the color difference of an image between a source color space and a target color space with a display of a computer system, comprising the steps of:
A. calculating the color values of an image pixel in source color space;
B. calculating the color values of the image pixel in target color space;
C. calculating the color values of the image pixel in system display color space and displaying the color on the corresponding pixel in an image diagram on the system display;
D. calculating the color difference of the image pixel in the source color space and target color space;
E. transforming the said color difference into the input values of the display so that the value of the said color difference can be identified by the color shown on the display with the input values;
F. displaying the color representing the value of the said color difference on the corresponding pixel in a color-difference diagram on the system display; and
G. repeating step A until all image pixels are processed.

22. A method for showing the color difference of an image between a target color space and the color space of a display of a computer system, comprising the steps of:
A. calculating the color values of an image pixel in source color space;
B. calculating the color values of the image pixel in target color space;
C. calculating the color values of the image pixel in system display color space and displaying the color on the corresponding pixel in an image diagram on the system display;
D. calculating the color difference of the image pixel in the system display color space and target color space;
E. transforming the said color difference into the input values of the display so that the value of the said color difference can be identified by the color shown on the display with the input values;
F. displaying the color representing the value of the said color difference on the corresponding pixel in a color-difference diagram on the system display; and
G. repeating step A until all image pixels are processed.

23. An initializing process, including:
specifying an uniform color coordinate system;
specifying an image source color space;
specifying an image target color space;
specifying the system display color space;
specifying a color gamut mapping method to transform the color values of the image from the specified source color space into the specified target color space;
specifying a gamut mapping method with absolute rendering intent for transforming the color values of the image from the specified target color space into the specified system display color space;

24. An interactive graphical user interface, comprising:
an activation function for enabling the software system;
a function for adjusting image lightness;
an indicator for showing the increment of image lightness;
a function for adjusting a color-shift enhancement factor so that the lightness and saturation of the said offset-color-shift on the said offset-color-shift diagram is increased;
a function for resetting the said color-shift enhancement factor to unit and the said offset-color-shift on the said offset-color-shift diagram is reset to its original;
an image diagram;
an offset-color-shift diagram;
a color patch showing the color of the selected pixel in the said image diagram;
a color patch showing the color of the said offset-color;
a color patch showing the color of the said offset-color-shift;
a color-space diagram showing the positions of the color of the image pixel in two color spaces; and
graphical symbols on the same corresponding pixels of the said image diagram and offset-color-shift diagram, and a graphic symbol showing the positions of the pixel color in two color spaces on the said color-space diagram when a user selects the pixel of either one of the said image diagram and offset-color-shift diagram through a human-computer interface;

25. An interactive graphical user interface, comprising:
an activation function for enabling the software system;
a function for adjusting image lightness;
an indicator for showing the increment of image lightness;
an image diagram;
a color-difference diagram;
a color patch showing the color of the selected pixel in the said image diagram;
a color-difference scale relating the color representing the value of the said color difference to the value of the said color difference; and
graphical symbols on the same corresponding pixels of the said image diagram and color-difference diagram, and a graphical symbol pointing to the corresponding position of the said color-difference scale when a user selects the pixel of either one of the said image diagram and color-difference diagram through a human-computer interface;

26. The interactive graphical user interface of claim 24, further comprising:
color space specification function for specifying the color spaces of image source, system display, and target;
gamut mapping method options including absolute rendering intent, relative rendering intent, perceptual rendering intent, saturation rendering intent, and the other intents;
a tool for editing the parameters used in the selected gamut mapping method.

27. The interactive graphical user interface of claim 25, further comprising:
color space specification function for specifying the color spaces of image source, system display, and target;
gamut mapping method options including absolute rendering intent, relative rendering intent, perceptual rendering intent, saturation rendering intent, and the other intents;
a tool for editing the parameters used in the selected gamut mapping method.

28. An image color editing method for the software system, comprising:
color edit mode options including “global-pixel”, “local-pixel”, “global-color”, and “local-color”, where the edit mode with “global-pixel” option applies edit commands to all image pixels, while the edit mode with “local-pixel” option only applies to the selected pixels or areas of the image, and the edit mode with “global-color” option applies edit commands to all color, while the edit mode with “local-color” option only applies to the selected colors of the image;
tools for selecting the clustered pixels to be edited in the diagrams, including a graphical user interface tool for selecting an area of geometrical shape, and a graphical user interface tool with an object recognition function for identifying the space boundary of an object, where if this function is applied to the image diagram, user can edit the color of a thing in the image, and if this function is applied to an offset-color-shift diagram to select an area with unwanted color shift, user can edit the color of the corresponding pixels of the area in image diagram, and if this function is applied to a color-difference diagram to select an area with unwanted color difference, user can edit the color of the corresponding pixels of the area in image diagram;
tools for selecting edited color with the logical operations for the conditions of the color value of image diagram, the color shift of offset-color-shift diagrams, and the color difference of color-difference diagram that is to be edited in the selected image pixels; and
functions for editing the selected color of the selected image pixels, which includes tuning the ratios among the red, green, blue colorants for additive color system; the ratios among cyan, magenta, yellow, and black colorants for subtractive color system; the lightness, hue, and saturation of the selected color.
